(19) United States
(12) Patent Application Publication
(10) Pub. No.: US 2024/0112226 A1
(43) Pub. Date: Apr. 4, 2024

(54) INFORMATION TRANSMISSION APPARATUS, INFORMATION PROCESSING METHOD, AND INFORMATION TRANSMISSION METHOD

(71) Applicants: NEC Corporation, Minato-ku, Tokyo (JP); NEC Platforms, Ltd., Kawasaki-shi, Kanagawa (JP)

(72) Inventors: Shunya MARUYAMA, Tokyo (JP); Yoshiki MATSUMOTO, Tokyo (JP); Hiroaki SATO, Tokyo (JP); Erina TANAKA, Kanagawa (JP); Mami KIMURA, Kanagawa (JP)

(73) Assignees: NEC Corporation, Minato-ku, Tokyo (JP); NEC Platforms, Ltd., Kawasaki-shi, Kanagawa (JP)

(21) Appl. No.: 18/274,900

(22) PCT Filed: Mar. 19, 2021
(86) PCT No.: PCT/JP2021/011439

§ 371 Date: Jul. 28, 2023

(51) Int. Cl. G06Q 30/02; H04M 3/51; H04W 64/00

(52) U.S. Cl. CPC G06Q 30/0281; H04M 3/5183; H04W 64/006

(57) ABSTRACT

An information transmission apparatus can use a salesclerk information storage unit. The salesclerk information storage unit stores, by a plurality of salesclerks, salesclerk identification information about the salesclerk and detailed information about the salesclerk in association with each other. Then, the information transmission apparatus includes a salesclerk position transmission unit and a detailed information transmission unit. The salesclerk position transmission unit transmits, for each of a plurality of salesclerks present in a store, salesclerk position information about the salesclerk and salesclerk identification information about the salesclerk in association with each other to a customer terminal. When the detailed information transmission unit receives any piece of the salesclerk identification information from the customer terminal, the detailed information transmission unit reads detailed information associated with the salesclerk identification information from the salesclerk information storage unit, and transmits the detailed information to the customer terminal.

### TECHNICAL FIELD

The present invention relates to an information transmission apparatus, an information processing method, and an information transmission method.

### BACKGROUND ART

In recent years, providing various types of information to a customer who visits a store has been considered. For example, Patent Document 1 describes that a floor map is displayed on a terminal of a customer, and a position of the terminal of the customer and a position of a terminal of a salesclerk are also displayed on the floor map.

Further, Patent Document 2 discloses a technique for calling an appropriate staff member according to a product selected by a customer. Specifically, a customer with a selected product goes to a product-reading apparatus installed in a store, and causes the product-reading apparatus to read a bar code of the product. The product-reading apparatus transmits read information to a management apparatus. The management apparatus determines a candidate for a staff member to be called by using the read information, and transmits calling information to a portable apparatus held by the candidate. At this time, the management apparatus refers to a staff information management database. The staff information management database includes information indicating a classification of a product of which the staff member can be in charge, and information indicating whether customer service is available.

### RELATED DOCUMENT

### Patent Document

Patent Document 1: Japanese Patent Application Publication No. 2016-103826
Patent Document 2: Japanese Patent Application Publication No. 2017-207999

### SUMMARY OF INVENTION

### Technical Problem

When a customer requests an explanation of a product from a salesclerk, the customer himself/herself may desire to select the salesclerk. In order to respond to this, it is desirable to provide information about the salesclerk to the customer. One example of an object of the present invention is to provide information about a salesclerk to a customer.

### Solution to Problem

The present invention provides a first information transmission apparatus including:
a salesclerk position transmission unit that transmits, for each of a plurality of salesclerks present in a store, salesclerk position information indicating a position of the salesclerk and salesclerk identification information that identifies the salesclerk in association with each other to a customer terminal possessed by a customer; and
a detailed information transmission unit that reads, from a storage unit that stores, for each of the plurality of salesclerks, the salesclerk identification information and detailed information about the salesclerk, the detailed information associated with the salesclerk identification information, when any piece of the salesclerk identification information is received from the customer terminal, and transmits the detailed information to the customer terminal.

The present invention provides a second information transmission apparatus including:
a salesclerk position transmission unit that transmits, for each of a plurality of salesclerks present in a store, salesclerk position information indicating a position of the salesclerk and salesclerk identification information that identifies the salesclerk in association with each other to a customer terminal possessed by a customer;
a salesclerk selection unit that selects, when product determination information that determines a product needed to be explained to a customer is acquired from the customer terminal, the salesclerk associated with the product determined by the product determination information, by using a storage unit that stores, for each of the plurality of salesclerks, a product that can be explained by the salesclerk; and
a selection result transmission unit that transmits the salesclerk identification information about the salesclerk selected by the salesclerk selection unit to the customer terminal.

The present invention provides a program for causing a terminal including a display to function as the customer terminal used together with the first information transmission apparatus described above,
the program causing the terminal to include:
   a position display function of causing the display to perform position display indicating a position of each of the plurality of salesclerks by using a plurality of pieces of the salesclerk position information;
   a transmission function of transmitting the salesclerk identification information about the salesclerk to the information transmission apparatus when any of the salesclerks is selected; and
   a detail display function of causing the display to perform display of the detailed information about the selected salesclerk when the detailed information is received from the information transmission apparatus.

The present invention provides a program for causing a terminal including a display to function as the customer terminal used together with the second information transmission apparatus described above,
the program causing the terminal to include:
   a position display function of causing the display to display a position of the salesclerk indicated by the salesclerk position information on a map about the inside of the store; and
   a selection acquisition function of acquiring the product determination information, and transmitting the product determination information to the information transmission apparatus, in which
the position display function displays, on the map in a distinguishable manner from another salesclerk, the salesclerk indicated by the salesclerk identification information transmitted by the selection result transmission unit.

The present invention provides an information transmission method including,
by a computer:
salesclerk position transmission processing of transmitting, for each of a plurality of salesclerks present in a store, salesclerk position information indicating a position of the salesclerk and salesclerk identification information that identifies the salesclerk in association with each other to a customer terminal; and
detailed information transmission processing of reading, from a storage unit that stores, for each of the plurality of salesclerks, the salesclerk identification information and detailed information about the salesclerk, the detailed information associated with the salesclerk identification information, when any piece of the salesclerk identification information is received from the customer terminal, and transmitting the detailed information to the customer terminal.

The present invention provides an information transmission method including,
by a computer:
salesclerk position transmission processing of transmitting, for each of a plurality of salesclerks present in a store, salesclerk position information indicating a position of the salesclerk and salesclerk identification information that identifies the salesclerk in association with each other to a customer terminal possessed by a customer;
salesclerk selection processing of selecting, when product determination information indicating a product selected by a customer is acquired from the customer terminal, the salesclerk associated with the product indicated by the product determination information, by using a storage unit that stores, for each of the plurality of salesclerks, a product of which the salesclerk is in charge; and
selection result transmission processing of transmitting the salesclerk identification information about the salesclerk selected in the salesclerk selection processing to the customer terminal.

The present invention provides an information processing method including,
by the customer terminal used together with the first information transmission apparatus described above:
position display processing of causing a display to perform position display indicating a position of each of the plurality of salesclerks by using a plurality of pieces of the salesclerk position information;
transmission processing of transmitting the salesclerk identification information about the salesclerk to the information transmission apparatus when any of the salesclerks is selected; and
detail display processing of causing the display to perform display of the detailed information when the detailed information is received from the information transmission apparatus.

The present invention provides an information processing method including,
by the customer terminal used together with the second information transmission apparatus described above:
map information display processing of causing a display to display a position of the salesclerk indicated by the salesclerk position information on a map about the inside of the store;
selection acquisition processing of receiving an input of the product determination information; and
transmission processing of transmitting the product determination information to the information transmission apparatus,
the information processing method further including, in the map information display processing, by the customer terminal, displaying, on the map in a distinguishable manner from another salesclerk, the salesclerk indicated by the salesclerk identification information transmitted by the selection result transmission unit.

The present invention provides a program causing a computer to include:
a salesclerk position transmission function of transmitting, for each of a plurality of salesclerks present in a store, salesclerk position information indicating a position of the salesclerk and salesclerk identification information that identifies the salesclerk in association with each other to a customer terminal; and
a detailed information transmission function of reading, from a storage unit that stores, for each of the plurality of salesclerks, the salesclerk identification information and detailed information about the salesclerk, the detailed information associated with the salesclerk identification information, when any piece of the salesclerk identification information is received from the customer terminal, and transmitting the detailed information to the customer terminal.

The present invention provides a program causing a computer to include:
a salesclerk position transmission function of transmitting, for each of a plurality of salesclerks present in a store, salesclerk position information indicating a position of the salesclerk and salesclerk identification information that identifies the salesclerk in association with each other to a customer terminal possessed by a customer;
a salesclerk selection function of selecting, when product determination information indicating a product selected by a customer is acquired from the customer terminal, the salesclerk associated with the product indicated by the product determination information, by using a storage unit that stores, for each of the plurality of salesclerks, a product of which the salesclerk is in charge; and
a selection result transmission function of transmitting the salesclerk identification information about the salesclerk selected by using the salesclerk selection function to the customer terminal.

The present invention provides the customer terminal used together with the first information transmission apparatus described above, the customer terminal including:
a position display unit that causes a display to perform position display indicating a position of each of the plurality of salesclerks by using a plurality of pieces of the salesclerk position information;
a transmission unit that transmits the salesclerk identification information about the salesclerk to the information transmission apparatus when any of the salesclerks is selected; and
a detail display unit that causes the display to perform display of the detailed information when the detailed information is received from the information transmission apparatus.

The present invention provides the customer terminal used together with the second information transmission apparatus described above, the customer terminal including:
a map information display unit that causes a display to display a position of the salesclerk indicated by the salesclerk position information on a map about the inside of the store;
a selection acquisition unit that receives an input of the product determination information; and
a transmission unit that transmits the product determination information to the information transmission apparatus; in which
the map information display unit displays, on the map in a distinguishable manner from another salesclerk, the salesclerk indicated by the salesclerk identification information transmitted by the selection result transmission unit.

### Advantageous Effects of Invention

The present invention can provide information about a salesclerk to a customer.

### BRIEF DESCRIPTION OF THE DRAWINGS

The above-described object, other objects, features, and advantages will become more apparent from suitable example embodiments described below and the following accompanying drawings.

FIG. 1 It is a diagram illustrating a configuration of an information transmission system according to a first example embodiment.

FIG. 2 It is a diagram illustrating one example of a functional configuration of an information transmission apparatus.

FIG. 3 It is a diagram illustrating one example of information stored in a salesclerk information storage unit.

FIG. 4 It is a diagram illustrating one example of a functional configuration of a customer terminal.

FIG. 5 It is a diagram illustrating a hardware configuration example of the information transmission apparatus.

FIG. 6 It is a flowchart illustrating a first example of processing performed by the information transmission system illustrated in FIG. 1.

FIG. 7 It is a flowchart illustrating a first detailed example of step S100 in FIG. 6.

FIG. 8 It is a flowchart illustrating a second detailed example of step S100 in FIG. 6.

FIG. 9 It illustrates one example of a screen displayed on a display of the customer terminal in step S40 in FIG. 6.

FIG. 10 It illustrates a first example of a screen displayed on the display of the customer terminal in step S90 in FIG. 6.

FIG. 11 It illustrates a second example of a screen displayed on the display of the customer terminal in step S90 in FIG. 6.

FIG. 12 It is a flowchart illustrating a second example of the processing performed by the information transmission system illustrated in FIG. 1.

FIG. 13 It is a diagram illustrating one example of a functional configuration of an information transmission apparatus according to a second example embodiment.

FIG. 14 It is a diagram illustrating a functional configuration example of a customer terminal according to the second example embodiment.

FIG. 15 It is a flowchart illustrating one example of processing performed by the information transmission system according to the second example embodiment.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

### First Example Embodiment

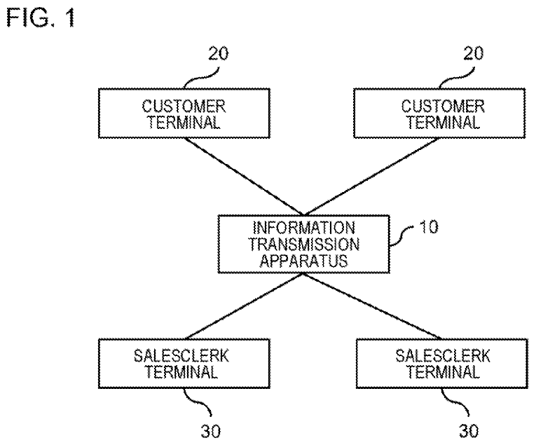

FIG. 1 is a diagram illustrating a configuration of an information transmission system according to the present example embodiment. The information transmission system includes an information transmission apparatus 10, at least one customer terminal 20, and a plurality of salesclerk terminals 30, and provides information about a salesclerk of a store to a customer in the store.

The customer terminal 20 is a terminal held by a customer, and the salesclerk terminal 30 is a terminal held by a salesclerk. The information transmission apparatus 10 transmits, to the customer terminal 20, information (hereinafter, described as salesclerk position information) indicating a position of a salesclerk in a store together with information (hereinafter, described as salesclerk identification information) that identifies the salesclerk. The customer terminal 20 performs display based on the salesclerk position information. Then, a customer inputs, to the customer terminal 20, information that specifies a salesclerk desired by the customer to give an explanation. Then, the customer terminal 20 transmits, to the information transmission apparatus 10, the salesclerk identification information about the specified salesclerk and information (hereinafter, described as customer position information) indicating a current position of the customer terminal 20 (i.e., a current position of the customer). The information transmission apparatus 10 transmits the customer position information to the salesclerk terminal 30 associated with the salesclerk identification information. In this way, the information transmission apparatus 10 prompts the salesclerk to serve the customer.

Herein, the information transmission apparatus 10 preferably transmits, to the customer terminal 20, information (hereinafter, described as store map information) indicating a floor map of the store together with the salesclerk position information. In this case, the customer terminal 20 displays the floor map, and also displays a position of each salesclerk and a position of the customer terminal 20 on the floor map. In this way, the customer can easily recognize a position of the salesclerk in a real space.

Note that, the customer terminal 20 is, for example, a smartphone and a tablet terminal, but may be a wearable terminal. The salesclerk terminal 30 is also, for example, a smartphone and a tablet terminal, but may be a wearable terminal. Further, the customer terminal 20 may be a terminal possessed by a customer (for example, the customer installs an application program in the terminal), or may be a terminal prepared on a store side and lent to a customer.

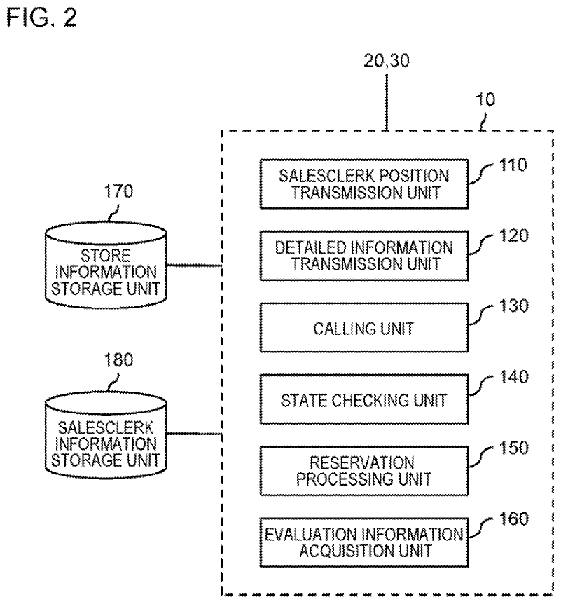

FIG. 2 is a diagram illustrating one example of a functional configuration of the information transmission apparatus 10. In the example illustrated in FIG. 2, the information transmission apparatus 10 can use a store information storage unit 170 and a salesclerk information storage unit 180. The store information storage unit 170 and the salesclerk information storage unit 180 are a part of the information transmission apparatus 10. However, at least one of the store information storage unit 170 and the salesclerk information storage unit 180 may be located outside the information transmission apparatus 10.

The store information storage unit 170 stores information about a store, for example, the store map information described above.

The salesclerk information storage unit 180 stores, for each of a plurality of salesclerks, salesclerk identification information about the salesclerk and detailed information about the salesclerk in association with each other. The detailed information includes information indicating whether a salesclerk is available, for example, information (hereinafter, described as state information) indicating whether a salesclerk is serving a customer. Further, the salesclerk information storage unit 180 stores the salesclerk identification information in association with information (hereinafter, described as salesclerk terminal identification information) that identifies the salesclerk terminal 30 possessed by the salesclerk. Note that, details of the information stored in the salesclerk information storage unit 180 will be described below by using another drawings.

Then, the information transmission apparatus 10 includes a salesclerk position transmission unit 110 and a detailed information transmission unit 120.

The salesclerk position transmission unit 110 transmits, for each of a plurality of salesclerks present in a store, salesclerk position information about the salesclerk and salesclerk identification information about the salesclerk in association with each other to the customer terminal 20. At this time, the salesclerk position transmission unit 110 also transmits the store map information described above, as necessary. In this case, the salesclerk position transmission unit 110 reads the store map information from the store information storage unit 170.

When the detailed information transmission unit 120 receives any piece of the salesclerk identification information from the customer terminal 20, the detailed information transmission unit 120 reads detailed information associated with the salesclerk identification information from the salesclerk information storage unit 180, and transmits the detailed information to the customer terminal 20. The customer terminal 20 displays the detailed information.

The information transmission apparatus 10 further includes a calling unit 130, a state checking unit 140, a reservation processing unit 150, and an evaluation information acquisition unit 160.

The customer terminal 20 transmits, to the information transmission apparatus 10, information (hereinafter, described as calling information) indicating that a customer calls a salesclerk desired by the customer to give an explanation. The calling information includes salesclerk identification information about the salesclerk desired by the customer to give an explanation. The calling unit 130 acquires the salesclerk identification information from the customer terminal 20. The calling unit 130 reads, from the salesclerk information storage unit 180, salesclerk terminal identification information associated with the salesclerk identification information acquired from the customer terminal 20, and transmits information indicating that there is a call from a customer to the salesclerk terminal 30 indicated by the salesclerk terminal identification information. At this time, the calling unit 130 preferably transmits customer position information to the salesclerk terminal 30.

The state checking unit 140 checks whether the salesclerk being a target of the calling information is available by using the salesclerk information storage unit 180. Specifically, the state checking unit 140 recognizes salesclerk identification information included in the calling information, and reads state information associated with the salesclerk identification information from the salesclerk information storage unit 180. Then, the state checking unit 140 checks whether the salesclerk is available by using the state information.

When a check result by the state checking unit 140 indicates that the salesclerk is not available, the reservation processing unit 150 performs reservation processing for causing the salesclerk to serve the customer who possesses the customer terminal 20. As one example of the reservation processing, reservation information is stored in the salesclerk information storage unit 180, and information indicating that a reservation for customer service has been made is also transmitted to the salesclerk terminal 30. The reservation information and the information transmitted to the salesclerk terminal 30 include, for example, information about the customer who has reserved the salesclerk (for example, customer position information about the customer).

The evaluation information acquisition unit 160 acquires, from the customer terminal 20, information (hereinafter, described as evaluation information) indicating an evaluation result of a salesclerk of which detailed information has been transmitted. More specifically, after the detailed information is transmitted, the evaluation information acquisition unit 160 transmits a screen for inputting the evaluation information to the customer terminal 20. A customer inputs the evaluation information to the screen. Then, the customer terminal 20 transmits the input evaluation information to the information transmission apparatus 10.

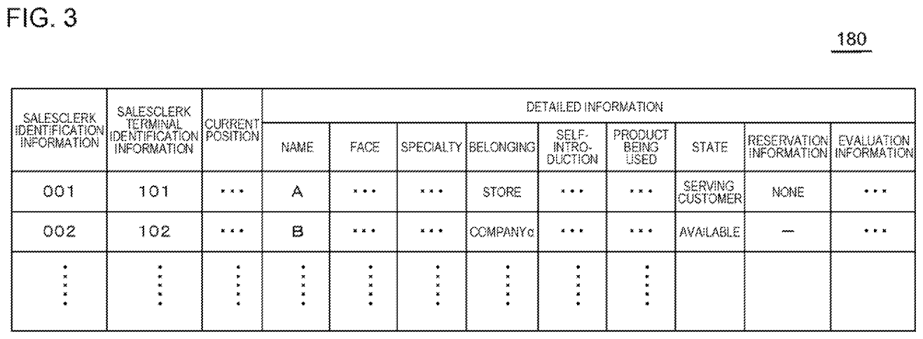

FIG. 3 is a diagram illustrating one example of the information stored in the salesclerk information storage unit 180. As described above, the salesclerk information storage unit 180 stores, for each of a plurality of salesclerks, salesclerk identification information, salesclerk terminal identification information, a current position of the salesclerk terminal 30, and detailed information about the salesclerk in association with one another. In the example illustrated in FIG. 3, the detailed information includes, in addition to the state information described above, a name of the salesclerk, face information (for example, a face picture) of the salesclerk, information (for example, a product category of which the salesclerk is in charge) about a specialty of the salesclerk, information (for example, an employee of an operating company of the store, a person dispatched from an external company (for example, a manufacturer), or the like) about a company to which the salesclerk belongs, a self-introduction sentence input by the salesclerk, information (for example, a product name, or the like) about a product being actually used by the salesclerk, the reservation information described above, and the evaluation information described above.

Note that, a current position of the salesclerk terminal 30 is transmitted from the salesclerk terminal 30. The salesclerk terminal 30 computes a current position by using a GPS, for example. The salesclerk terminal 30 may compute a current position by using a difference in intensity or arrival time of an electric wave being acquired from a plurality of wireless transmission apparatuses (for example, access points of WiFi (registered trademark) or beacon transmitters) installed in a store.

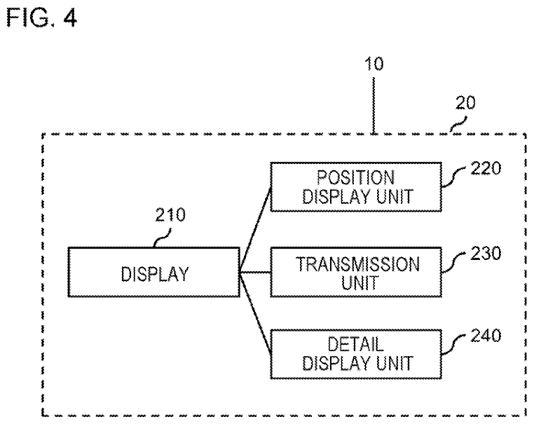

FIG. 4 is a diagram illustrating one example of a functional configuration of the customer terminal 20. The customer terminal 20 includes a display 210, a position display unit 220, a transmission unit 230, and a detail display unit 240. As described above, the customer terminal 20 acquires salesclerk position information and salesclerk identification information about each of a plurality of salesclerks from the information transmission apparatus 10.

The position display unit 220 causes the display 210 to perform position display indicating a position of each of a plurality of salesclerks by using a plurality of pieces of salesclerk position information acquired from the information transmission apparatus 10. For example, the position display unit 220 displays a mark indicating a salesclerk in a position associated with the position of each of the plurality of salesclerks on a floor map of a store.

Each of the plurality of salesclerks is displayed on the display 210 in such a way that the salesclerk can be selected. When the display 210 is a touch panel, the selection is performed via the display 210, for example.

Further, the position display unit 220 computes terminal position information by using a GPS, for example. The position display unit 220 may compute the terminal position information by using a difference in intensity or arrival time of an electric wave being acquired from a plurality of wireless transmission apparatuses (for example, access points of WiFi (registered trademark) or beacon transmitters) installed in a store.

Then, the position display unit 220 acquires the terminal position information about the customer terminal 20. Then, the position display unit 220 may display a mark indicating a customer in a position indicated by the terminal position information on a floor map of the store.

When any salesclerk of a plurality of salesclerks displayed on the display 210 is selected by a customer, the transmission unit 230 transmits salesclerk identification information about the salesclerk to the information transmission apparatus 10. The information transmission apparatus 10 transmits detailed information associated with the salesclerk identification information to the customer terminal 20.

Further, the transmission unit 230 performs processing for a customer to input evaluation information, and also transmits the evaluation information to the information transmission apparatus 10.

When the detail display unit 240 receives the detailed information about the salesclerk from the information transmission apparatus 10, the detail display unit 240 displays the detailed information on the display 210.

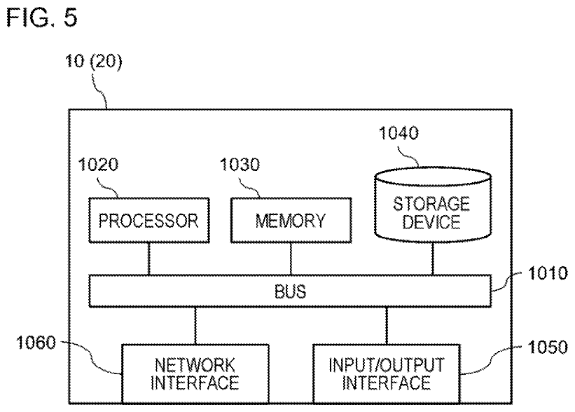

FIG. 5 is a diagram illustrating a hardware configuration example of the information transmission apparatus 10. The information transmission apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to one another is not limited to bus connection.

The processor 1020 is a processor achieved by a central processing unit (CPU), a graphics processing unit (GPU), and the like.

The memory 1030 is a main storage device achieved by a random access memory (RAM) and the like.

The storage device 1040 is an auxiliary storage device achieved by a hard disk drive (HDD), a solid state drive (SSD), a memory card, a read only memory (ROM), or the like. The storage device 1040 stores a program module that achieves each function (for example, the salesclerk position transmission unit 110, the detailed information transmission unit 120, the calling unit 130, the state checking unit 140, the reservation processing unit 150, and the evaluation information acquisition unit 160, and a salesclerk selection unit 410 and a selection result transmission unit 420 described in another example embodiment) of the information transmission apparatus 10. The processor 1020 reads each program module onto the memory 1030 and executes the program module, and each function associated with the program module is achieved. Further, the storage device 1040 also functions as the store information storage unit 170 and the salesclerk information storage unit 180.

The input/output interface 1050 is an interface for connecting the information transmission apparatus 10 and various types of input/output equipment.

The network interface 1060 is an interface for connecting the information transmission apparatus 10 to a network. The network is, for example, a local area network (LAN) and a wide area network (WAN). A method of connection to the network by the network interface 1060 may be wireless connection or wired connection. The information transmission apparatus 10 may communicate with the customer terminal 20 and the salesclerk terminal 30 via the network interface 1060.

Note that, a hardware configuration of the customer terminal 20 is also similar to the example illustrated in FIG. 5. In this case, the storage device 1040 stores a program module that achieves each function (for example, the position display unit 220, the transmission unit 230, and the detail display unit 240, and a selection acquisition unit 250 in another example embodiment described below) of the customer terminal 20.

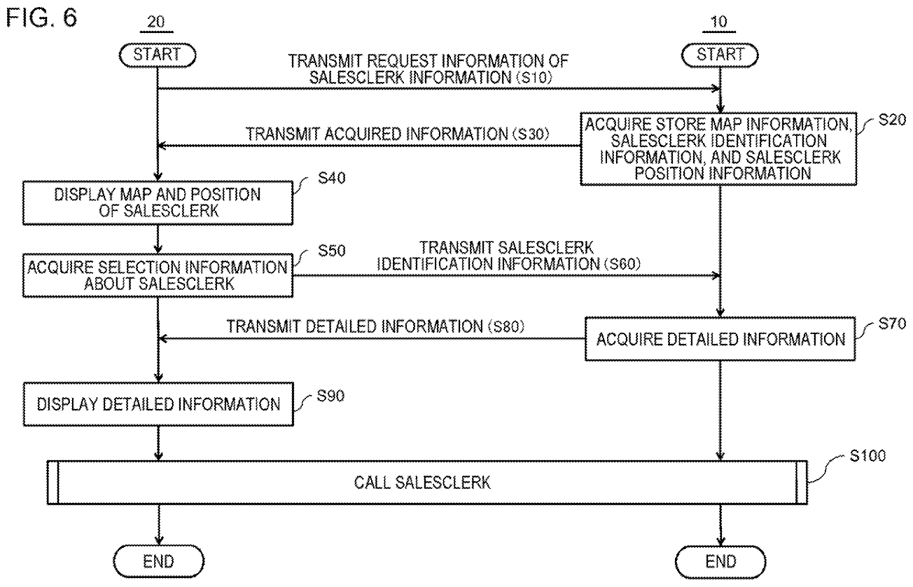

FIG. 6 is a flowchart illustrating a first example of processing performed by the information transmission system illustrated in FIG. 1. In the processing illustrated in FIG. 6, the salesclerk terminal 30 repeatedly computes a current position of the salesclerk terminal 30, and transmits the current position to the information transmission apparatus 10. Then, the information transmission apparatus 10 updates a current position stored in the salesclerk information storage unit 180 to a newly received current position.

A customer with the customer terminal 20 enters a store and moves around in the store. Meanwhile, the position display unit 220 of the customer terminal 20 repeatedly computes terminal position information about the customer terminal 20, i.e., information indicating a current position. When the customer desires to receive, from a salesclerk, an explanation about the inside of the store, for example, an explanation of a product, the customer causes the customer terminal 20 to transmit, to the information transmission apparatus 10, information (hereinafter, described as request information) indicating a request for salesclerk information (step S10).

Then, the salesclerk position transmission unit 110 of the information transmission apparatus 10 reads store map information from the store information storage unit 170, and also reads salesclerk identification information and a current position of each of a plurality of salesclerks from the salesclerk information storage unit 180. At this time, the salesclerk position transmission unit 110 may read, from the salesclerk information storage unit 180, state information about each of the plurality of salesclerks, i.e., information indicating whether the salesclerk is serving a customer (step S20). Then, the salesclerk position transmission unit 110 transmits the read information to the customer terminal 20 (step S30).

When the position display unit 220 of the customer terminal 20 acquires, from the information transmission apparatus 10, the store map information, and the salesclerk identification information and the salesclerk position information about each of the plurality of salesclerks, the position display unit 220 displays a floor map on the display 210 by using the store map information. At this time, the position display unit 220 displays a mark indicating presence of a salesclerk in a position indicated by each of the plurality of pieces of salesclerk position information on the floor map, and also displays a mark indicating presence of a customer in a position indicated by the terminal position information on the floor map (step S40). Herein, when the position display unit 220 has received the state information from the information transmission apparatus 10, the position display unit 220 may change a display state (for example, at least one of a shape, a size, a color, and presence or absence of flashing) of the mark indicating presence of the salesclerk according to the state information. In this way, the customer can easily recognize a salesclerk serving a customer and a salesclerk being available.

The customer operates the customer terminal 20, and selects a salesclerk whose detailed information the customer desires to check (step S50). Then, the transmission unit 230 transmits the salesclerk identification information about the selected salesclerk to the information transmission apparatus 10 (step S60).

When the detailed information transmission unit 120 of the information transmission apparatus 10 acquires the salesclerk identification information from the customer terminal 20, the detailed information transmission unit 120 reads at least a part of the detailed information associated with the salesclerk identification information from the salesclerk information storage unit 180 (step S70), and transmits the read detailed information to the customer terminal 20 (step S80).

When the detail display unit 240 of the customer terminal 20 receives the detailed information about the salesclerk from the information transmission apparatus 10, the detail display unit 240 displays the detailed information on the display 210 (step S90). The customer studies the detailed information, and, when the customer desires to receive an explanation from the salesclerk, the customer performs an input for calling the salesclerk. Then, the information transmission system performs processing for calling the salesclerk (step S100).

Note that, in steps S20 and S30, the salesclerk position transmission unit 110 may generate a screen in which the mark indicating presence of a salesclerk and the mark indicating presence of a customer are superimposed on the floor map, and transmit the screen to the customer terminal 20. In this case, the position display unit 220 of the customer terminal 20 displays, on the display 210, the screen according to received screen information.

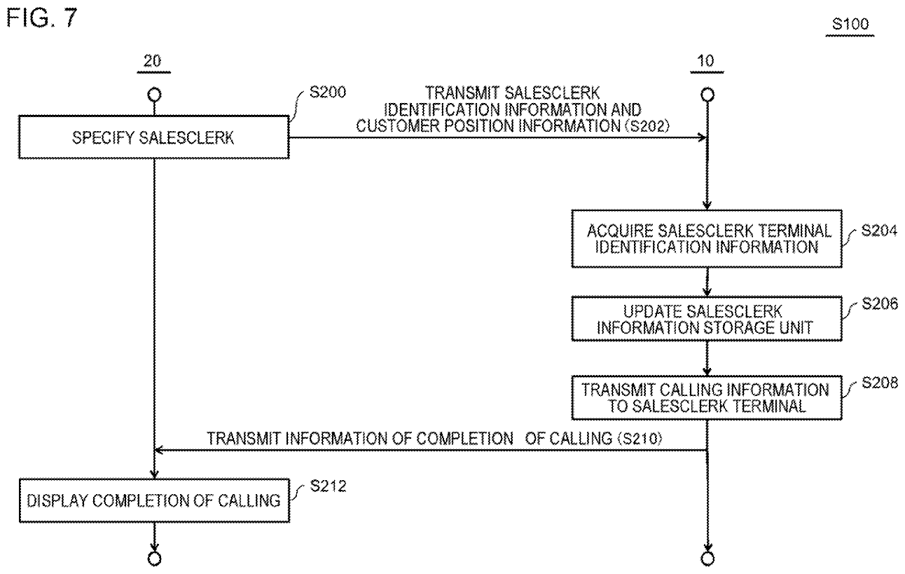

FIG. 7 is a flowchart illustrating a first detailed example of step S100 in FIG. 6. Processing illustrated in FIG. 7 is performed when a salesclerk desired by a customer for customer service is available.

The customer operates the customer terminal 20, and specifies a salesclerk from which the customer desires to receive an explanation (step S200). Then, the transmission unit 230 transmits salesclerk identification information about the specified salesclerk and customer position information together with information indicating that the customer desires for an explanation to the information transmission apparatus 10 (step S202).

The calling unit 130 of the information transmission apparatus 10 ascertains that the salesclerk is available by using state information associated with the salesclerk identification information acquired from the customer terminal 20. Then, the calling unit 130 reads, from the salesclerk information storage unit 180, salesclerk terminal identification information associated with the salesclerk identification information acquired from the customer terminal 20 (step S204). Further, the calling unit 130 updates the salesclerk information storage unit 180 in such a way that the state information about the salesclerk indicates that the salesclerk is serving a customer (step S206). Then, the calling unit 130 transmits calling information to the salesclerk terminal 30 indicated by the salesclerk terminal identification information read in step S204. The calling information includes information indicating presence of the customer who desires for customer service and the customer position information transmitted from the customer terminal 20 (step S208).

Subsequently, the calling unit 130 transmits information indicating completion of the calling processing of the salesclerk to the customer terminal 20 (step S210). Then, the customer terminal 20 displays completion of calling on the display 210 (step S212).

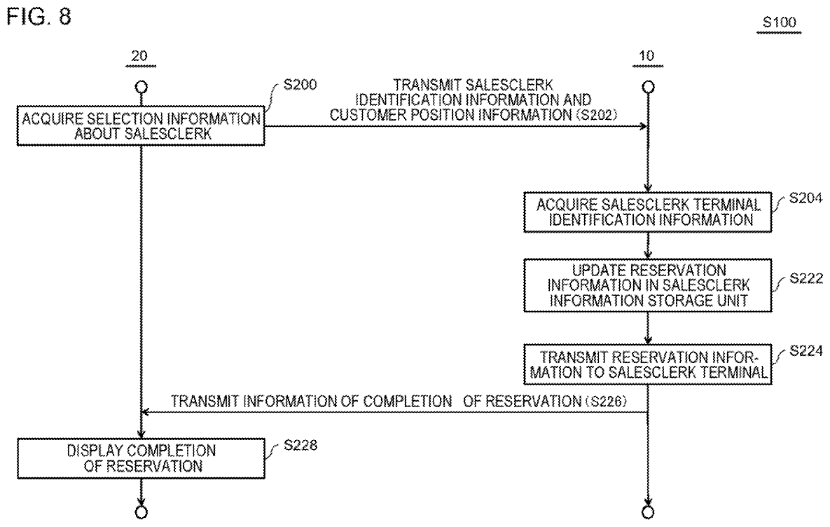

FIG. 8 is a flowchart illustrating a second detailed example of step S100 in FIG. 6. Processing illustrated in FIG. 8 is performed when a salesclerk selected by a customer is serving a customer.

Processing illustrated in step S200 to step S202 is similar to the processing illustrated in FIG. 7. Then, the calling unit 130 of the information transmission apparatus 10 ascertains that the salesclerk is serving a customer by using state information associated with the salesclerk identification information acquired from the customer terminal 20. Then, the reservation processing unit 150 of the information transmission apparatus 10 reads, from the salesclerk information storage unit 180, salesclerk terminal identification information associated with the salesclerk identification information acquired from the customer terminal 20 (step S204). Further, the reservation processing unit 150 updates reservation information in the salesclerk information storage unit 180 in such a way that a reservation for customer service has been made for the salesclerk (step S222). Then, the reservation processing unit 150 transmits reservation information to the salesclerk terminal 30 indicated by the salesclerk terminal identification information read in step S204 (step S224). The reservation information transmitted herein includes, for example, terminal position information about the customer who has made the reservation.

Subsequently, the reservation processing unit 150 transmits information indicating completion of the reservation processing of the salesclerk to the customer terminal 20 (step S226). Then, the customer terminal 20 displays completion of the reservation on the display 210 (step S228).

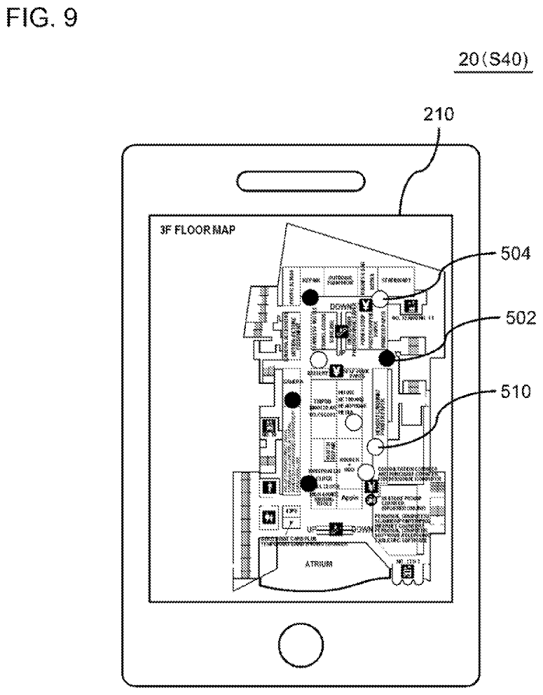

FIG. 9 illustrates one example of a screen displayed on the display 210 of the customer terminal 20 in step S40 in FIG. 6. In the example illustrated in FIG. 9, the display 210 displays a floor map of a store. The floor map has a mark 502 indicating a salesclerk serving a customer and a mark 504 indicating a salesclerk being available on it. The marks 502 and 504 are displayed in positions on the floor map corresponding to positions of the salesclerks in a real space. Further, the floor map also includes a mark 510 indicating a position of a customer. The mark 510 is displayed in a position associated with a position of the customer in the real space. Note that, the marks 502, 504, and 510 have display manners different from one another, and are thus distinguishable from one another.

Further, the marks 502 and 504 are selectable. When the customer selects a salesclerk whose detailed information is desired, the customer may select the mark 502 (or the mark 504) associated with the salesclerk.

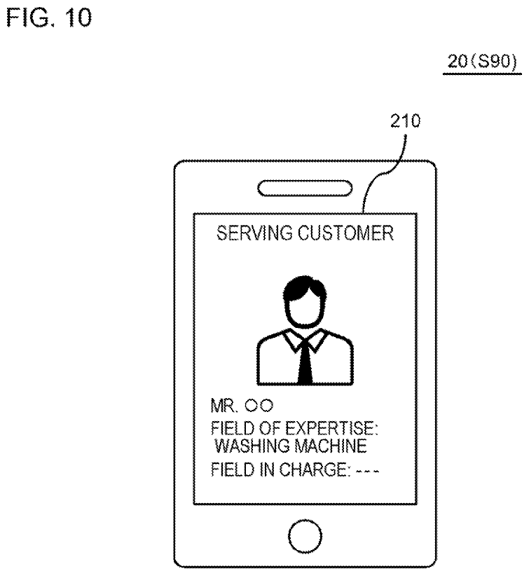

FIG. 10 illustrates a first example of a screen displayed on the display 210 of the customer terminal 20 in step S90 in FIG. 6. In the example illustrated in FIG. 10, the display 210 displays detailed information about a salesclerk.

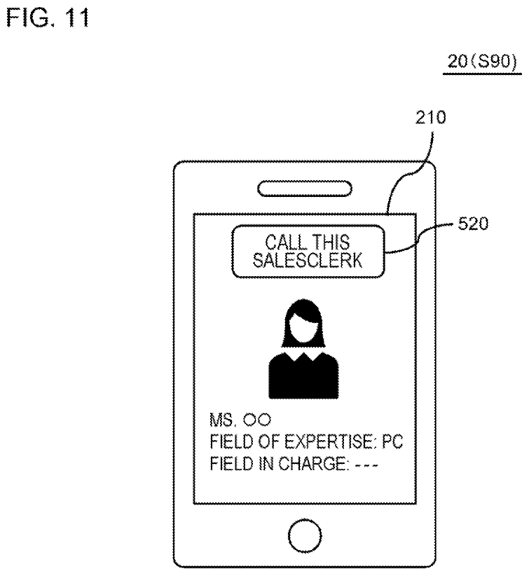

FIG. 11 illustrates a second example of a screen displayed on the display 210 of the customer terminal 20 in step S90 in FIG. 6. In the example illustrated in FIG. 11, the display 210 displays detailed information about a salesclerk, and also displays a calling button 520. When the calling button 520 is selected, the processing in and after step S200 illustrated in FIGS. 7 and 8 is performed.

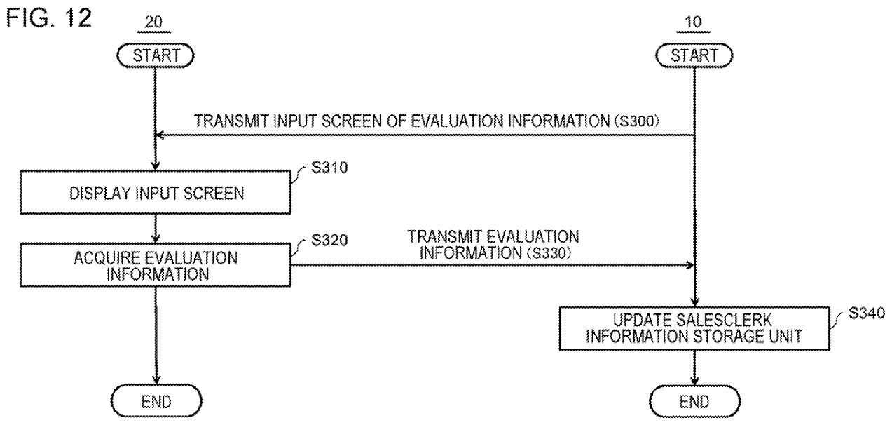

FIG. 12 is a flowchart illustrating a second example of the processing performed by the information transmission system illustrated in FIG. 1. The processing illustrated in FIG. 12 is performed when a customer is caused to evaluate a salesclerk. A timing at which the processing is performed is, for example, after customer service is provided by a salesclerk.

First, the evaluation information acquisition unit 160 of the information transmission apparatus 10 transmits, to the customer terminal 20, an input screen of evaluation information and salesclerk identification information about the salesclerk to be evaluated (step S300). At this time, the evaluation information acquisition unit 160 may further transmit a name and face information of the salesclerk. Then, the transmission unit 230 of the customer terminal 20 displays the input screen on the display 210 (step S310). Herein, the transmission unit 230 may further display the name and the face information of the salesclerk. A customer inputs the evaluation information to the input screen (step S320). Then, the transmission unit 230 transmits, to the information transmission apparatus 10, the evaluation information together with the salesclerk identification information acquired in step S300 (step S330).

Then, the evaluation information acquisition unit 160 of the information transmission apparatus 10 acquires the evaluation information and the salesclerk identification information transmitted from the customer terminal 20, and stores the evaluation information in association with the salesclerk identification information in the salesclerk information storage unit 180 (step S340).

As described above, according to the present example embodiment, the information transmission apparatus 10 causes the display 210 of the customer terminal 20 to display a position of a salesclerk in a store. Furthermore, the information transmission apparatus 10 causes the display 210 to display detailed information about a salesclerk selected by a customer. Therefore, the information transmission apparatus 10 can provide various types of information about the salesclerk to the customer.

### Second Example Embodiment

An information transmission system according to the present example embodiment is similar to the information transmission system according to the first example embodiment except for a point that the information transmission system according to the present example embodiment has a function of making it easy for a customer to recognize a salesclerk who can explain a product in which the customer is interested.

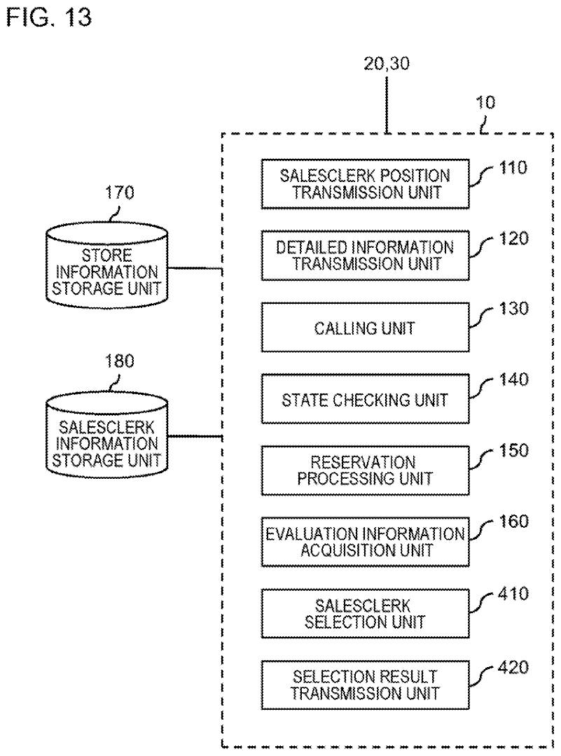

FIG. 13 is a diagram illustrating one example of a functional configuration of an information transmission apparatus 10 according to the present example embodiment. The information transmission apparatus 10 illustrated in FIG. 13 has a configuration similar to that of the information transmission apparatus 10 according to the first example embodiment except for a point that a salesclerk selection unit 410 and a selection result transmission unit 420 are further included.

The salesclerk selection unit 410 acquires, from a salesclerk terminal 30, information (hereinafter, described as product determination information) that determines a product needed to be explained to a customer. As described by using FIG. 3, detailed information about each salesclerk being stored in a salesclerk information storage unit 180 includes information (for example, information about a specialty and information about a product being actually used) indicating a product that can be explained by the salesclerk. Thus, the salesclerk selection unit 410 selects a salesclerk who can explain a product associated with the product determination information by using the detailed information about each salesclerk, and reads salesclerk identification information about the selected salesclerk from the salesclerk information storage unit 180.

The selection result transmission unit 420 transmits the salesclerk identification information read by the salesclerk selection unit 410 to a customer terminal 20. The customer terminal 20 displays the salesclerk associated with the salesclerk identification information in a distinguishable manner from another salesclerk. Note that, the customer terminal 20 may display only the salesclerk associated with the salesclerk identification information. In this way, the customer can recognize a position of the salesclerk who is an expert in the product indicated by the product determination information.

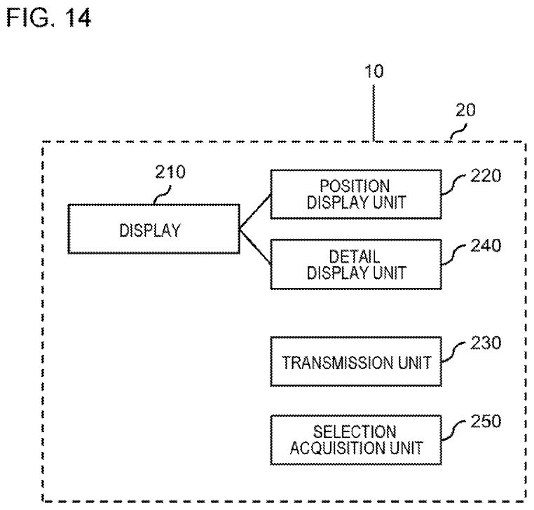

FIG. 14 is a diagram illustrating a functional configuration of the customer terminal 20 according to the present example embodiment. The customer terminal 20 illustrated in FIG. 14 has a configuration similar to that of the customer terminal 20 according to the first example embodiment except for a point that a selection acquisition unit 250 is further included.

The selection acquisition unit 250 acquires the product determination information described above. For example, a customer may input a product name as the product determination information to the selection acquisition unit 250.

Further, the floor map illustrated in FIG. 9 includes information indicating, for each area (for example, for each shelf) in a store, a product disposed at the area. In this case, the selection acquisition unit 250 may acquire information indicating that a part of the floor map has been selected, determine a product disposed in the part, and set information indicating the product as product determination information. Selection of a part of the floor map is performed by, for example, touching a region associated with the part on a display 210 having a touch panel function.

Further, a customer is often positioned near a product in which the customer is interested. Thus, the selection acquisition unit 250 may acquire terminal position information (i.e., information indicating a current position of the customer), determine a product disposed around a position indicated by the terminal position information by using the floor map illustrated in FIG. 9, and set information indicating the product as product determination information.

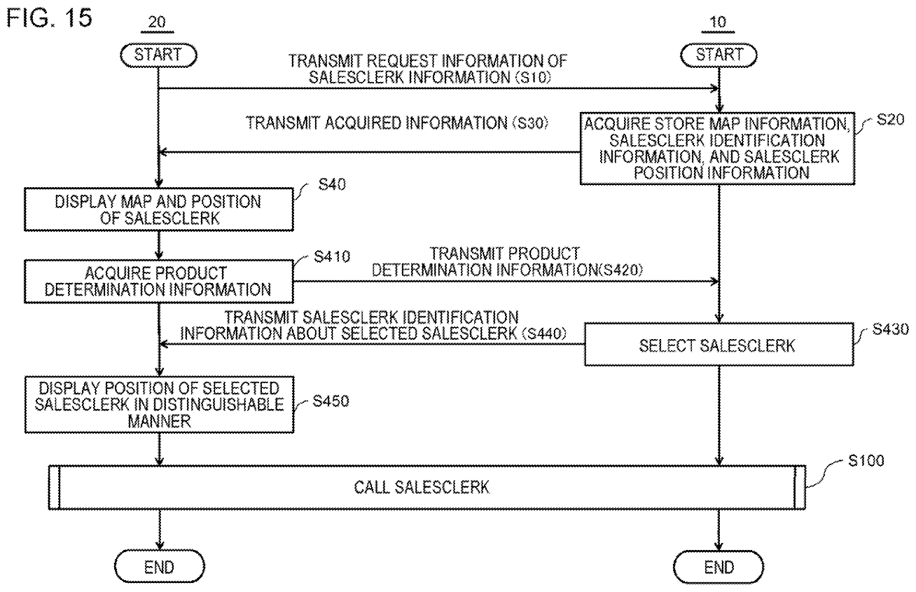

FIG. 15 is a flowchart illustrating one example of processing performed by the information transmission system according to the present example embodiment. In the present example embodiment, the information transmission system performs processing similar to that in the first example embodiment, and also performs the processing illustrated in FIG. 15.

Processing illustrated in step S10 to step S40 is similar to that in the example illustrated in FIG. 6. Then, when the selection acquisition unit 250 of the customer terminal 20 acquires product determination information (step S410), the selection acquisition unit 250 transmits the product determination information to the information transmission apparatus 10 (step S420).

The salesclerk selection unit 410 of the information transmission apparatus 10 selects a salesclerk associated with the product determination information acquired from the customer terminal 20 (step S430), and transmits salesclerk identification information about the salesclerk to the customer terminal 20 (step S440).

Then, a position display unit 220 of the customer terminal 20 sets, on the display 210, the salesclerk selected in step S430 in a distinguishable manner from another salesclerk by changing a display manner of a mark 502 (or a mark 504) of the salesclerk associated with the salesclerk identification information transmitted in step S440.

Subsequently, calling processing of the salesclerk is performed as necessary (step S100).

According to the present example embodiment, similarly to the first example embodiment, the information transmission apparatus 10 can also provide various types of information about a salesclerk to a customer. Further, when information indicating a product in which a customer seems to be interested is transmitted, the information transmission apparatus 10 causes the customer terminal 20 to display a position of a salesclerk who can explain the product in a distinguishable manner from another salesclerk. Therefore, the customer can easily select an appropriate salesclerk.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

Apart or the whole of the above-described example embodiment may also be described in supplementary notes below, which is not limited thereto.
1. An information transmission apparatus including:
   a salesclerk position transmission unit that transmits, for each of a plurality of salesclerks present in a store, salesclerk position information indicating a position of the salesclerk and salesclerk identification information that identifies the salesclerk in association with each other to a customer terminal possessed by a customer; and
   a detailed information transmission unit that reads, from a storage unit that stores, for each of the plurality of salesclerks, the salesclerk identification information and detailed information about the salesclerk, the detailed information associated with the salesclerk identification information, when any piece of the salesclerk identification information is received from the customer terminal, and transmits the detailed information to the customer terminal.
2. The information transmission apparatus according to supplementary note 1 described above, further including
   a calling unit that performs a predetermined output on a salesclerk terminal possessed by the salesclerk about whom the detailed information has been transmitted when calling information indicating that the customer calls the salesclerk is acquired from the customer terminal.
3. The information transmission apparatus according to supplementary note 2 described above, in which
   the information transmission apparatus can use a storage unit that stores, for each of the plurality of salesclerks, information indicating whether the salesclerk is available,
   the information transmission apparatus further including:
      a state checking unit that checks, by using the storage unit, whether the salesclerk being a target of the calling information is available when the calling information is acquired; and
      a reservation processing unit that performs reservation processing for causing the salesclerk to serve the customer when the salesclerk is not available.
4. The information transmission apparatus according to supplementary note 3 described above, in which
   the reservation processing unit transmits information indicating that the reservation processing has been performed to a salesclerk terminal possessed by the salesclerk.
5. The information transmission apparatus according to any one of supplementary notes 2 to 4 described above, in which
   the salesclerk terminal is a wearable terminal.
6. The information transmission apparatus according to any one of supplementary notes 1 to 5 described above, in which
   the detailed information includes at least one of face information about the salesclerk, information about a specialty of the salesclerk, information about a company to which the salesclerk belongs, a self-introduction sentence input by the salesclerk, information about a product being actually used by the salesclerk, and information indicating whether the salesclerk is available.
7. The information transmission apparatus according to any one of supplementary notes 1 to 6 described above, in which
   the salesclerk position transmission unit transmits, to the customer terminal, information indicating whether the salesclerk is available in association with the salesclerk position information and the salesclerk identification information.
8. The information transmission apparatus according to any one of supplementary notes 1 to 7 described above, further including
   an evaluation information acquisition unit that acquires, from the customer terminal, evaluation information indicating an evaluation result of the salesclerk about whom the detailed information has been transmitted.
9. The information transmission apparatus according to any one of supplementary notes 1 to 8 described above, in which
   the salesclerk position transmission unit transmits, to the customer terminal, map information about the store together with the salesclerk position information in order to display a position of the salesclerk on a map of the store.
10. An information transmission apparatus including:
   a salesclerk position transmission unit that transmits, for each of a plurality of salesclerks present in a store, salesclerk position information indicating a position of the salesclerk and salesclerk identification information that identifies the salesclerk in association with each other to a customer terminal possessed by a customer;
   a salesclerk selection unit that selects, when product determination information that determines a product needed to be explained to a customer is acquired from the customer terminal, the salesclerk associated with the product determined by the product determination information, by using a storage unit that stores, for each of the plurality of salesclerks, a product that can be explained by the salesclerk; and
   a selection result transmission unit that transmits the salesclerk identification information about the salesclerk selected by the salesclerk selection unit to the customer terminal.
11. A program for causing a terminal including a display to function as the customer terminal used together with the information transmission apparatus according to any one of claims 1 to 9,
   the program causing the terminal to include:
      a position display function of causing the display to perform position display indicating a position of each of the plurality of salesclerks by using a plurality of pieces of the salesclerk position information;
      a transmission function of transmitting the salesclerk identification information about the salesclerk to the information transmission apparatus when any of the salesclerks is selected; and
      a detail display function of causing the display to perform display of the detailed information about the selected salesclerk when the detailed information is received from the information transmission apparatus.
12. The program according to supplementary note 11 described above, in which the position display function also causes the display to display a position of the terminal.
13. A program for causing a terminal including a display to function as the customer terminal used together with the information transmission apparatus according to claim 10,
   the program causing the terminal to include:
      a position display function of causing the display to display a position of the salesclerk indicated by the salesclerk position information on a map about the inside of the store; and
      a selection acquisition function of acquiring the product determination information, and transmitting the product determination information to the information transmission apparatus, in which
   the position display function displays, on the map in a distinguishable manner from another salesclerk, the salesclerk indicated by the salesclerk identification information transmitted by the selection result transmission unit.
14. The program according to supplementary note 13 described above, in which
   the selection acquisition function
      receives an input of selection of a part of the map, and
      determines a product disposed at an area of the store associated with the part, and sets information indicating the product as the product determination information.
15. The program according to supplementary note 13 described above, in which
   the selection acquisition function
      acquires a position of the customer in the store, and
      determines a product disposed around the position, and sets information indicating the product as the product determination information.
16. An information transmission method including,
   by a computer:
   salesclerk position transmission processing of transmitting, for each of a plurality of salesclerks present in a store, salesclerk position information indicating a position of the salesclerk and salesclerk identification information that identifies the salesclerk in association with each other to a customer terminal; and
   detailed information transmission processing of reading, from a storage unit that stores, for each of the plurality of salesclerks, the salesclerk identification information and detailed information about the salesclerk, the detailed information associated with the salesclerk identification information, when any piece of the salesclerk identification information is received from the customer terminal, and transmitting the detailed information to the customer terminal.
17. The information transmission method according to supplementary note 16 described above, further including,
   by the computer,
   calling processing of performing a predetermined output on a salesclerk terminal possessed by the salesclerk about whom the detailed information has been transmitted when calling information indicating that the customer calls the salesclerk is acquired from the customer terminal.
18. The information transmission method according to supplementary note 17 described above, in which
   the computer can use a storage unit that stores, for each of the plurality of salesclerks, information indicating whether the salesclerk is available,
   the information transmission method further including,
   by the computer:
   state checking processing of checking, by using the storage unit, whether the salesclerk being a target of the calling information is available when the calling information is acquired; and
   reservation processing for causing the salesclerk to serve the customer when the salesclerk is not available.
19. The information transmission method according to supplementary note 18 described above, further including,
   in the reservation processing, by the computer,
   transmitting information indicating that the reservation processing has been performed to a salesclerk terminal possessed by the salesclerk.
20. The information transmission method according to any one of supplementary notes 17 to 19 described above, in which
   the salesclerk terminal is a wearable terminal.
21. The information transmission method according to any one of supplementary notes 16 to 20 described above, in which
   the detailed information includes at least one of face information about the salesclerk, information about a specialty of the salesclerk, information about a company to which the salesclerk belongs, a self-introduction sentence input by the salesclerk, information about a product being actually used by the salesclerk, and information indicating whether the salesclerk is available.
22. The information transmission method according to any one of supplementary notes 16 to 21 described above, further including,
   in the salesclerk position transmission processing, by the computer,
   transmitting, to the customer terminal, information indicating whether the salesclerk is available in association with the salesclerk position information and the salesclerk identification information.
23. The information transmission method according to any one of supplementary notes 16 to 22 described above, further including,
   by the computer,
   evaluation information acquisition processing of acquiring, from the customer terminal, evaluation information indicating an evaluation result of the salesclerk about whom the detailed information has been transmitted.
24. The information transmission method according to any one of supplementary notes 16 to 23 described above, further including,
   in the salesclerk position transmission processing, by the computer,
   transmitting, to the customer terminal, map information about the store together with the salesclerk position information in order to display a position of the salesclerk on a map of the store.
25. An information transmission method including,
   by a computer:
   salesclerk position transmission processing of transmitting, for each of a plurality of salesclerks present in a store, salesclerk position information indicating a position of the salesclerk and salesclerk identification information that identifies the salesclerk in association with each other to a customer terminal possessed by a customer;
   salesclerk selection processing of selecting, when product determination information indicating a product selected by a customer is acquired from the customer terminal, the salesclerk associated with the product indicated by the product determination information, by using a storage unit that stores, for each of the plurality of salesclerks, a product of which the salesclerk is in charge; and
   selection result transmission processing of transmitting the salesclerk identification information about the salesclerk selected in the salesclerk selection processing to the customer terminal.
26. An information processing method including,
   by the customer terminal used together with the information transmission apparatus according to any one of supplementary notes 1 to 9 described above:
   position display processing of causing a display to perform position display indicating a position of each of the plurality of salesclerks by using a plurality of pieces of the salesclerk position information;
   transmission processing of transmitting the salesclerk identification information about the salesclerk to the information transmission apparatus when any of the salesclerks is selected; and
   detail display processing of causing the display to perform display of the detailed information when the detailed information is received from the information transmission apparatus.
27. The information processing method according to supplementary note 26 described above, further including,
   in the position display processing, by the customer terminal,
   also causing the display to display a position of the terminal.
28. An information processing method including,
   by the customer terminal used together with the information transmission apparatus according to supplementary note 10 described above:
   map information display processing of causing a display to display a position of the salesclerk indicated by the salesclerk position information on a map about the inside of the store;
   selection acquisition processing of receiving an input of the product determination information; and
   transmission processing of transmitting the product determination information to the information transmission apparatus,
   the information processing method further including, in the map information display processing, by the customer terminal, displaying, on the map in a distinguishable manner from another salesclerk, the salesclerk indicated by the salesclerk identification information transmitted by the selection result transmission unit.
29. The information processing method according to supplementary note 28 described above, further including,
   in the selection acquisition processing, by the customer terminal:
   receiving an input of selection of a part of the map; and
   determining a product disposed at an area of the store associated with the part, and setting information indicating the product as the product determination information.
30. The information processing method according to supplementary note 28 described above, further including,
   in the selection acquisition processing, by the customer terminal:
   acquiring a position of the customer in the store; and
   determining a product disposed around the position; and setting information indicating the product as the product determination information.
31. A program causing a computer to include:
   a salesclerk position transmission function of transmitting, for each of a plurality of salesclerks present in a store, salesclerk position information indicating a position of the salesclerk and salesclerk identification information that identifies the salesclerk in association with each other to a customer terminal; and
   a detailed information transmission function of reading, from a storage unit that stores, for each of the plurality of salesclerks, the salesclerk identification information and detailed information about the salesclerk, the detailed information associated with the salesclerk identification information, when any piece of the salesclerk identification information is received from the customer terminal, and transmitting the detailed information to the customer terminal.
32. The program according to supplementary note 31 described above, further causing the computer to include
   a calling function of performing a predetermined output on a salesclerk terminal possessed by the salesclerk about whom the detailed information has been transmitted when calling information indicating that the customer calls the salesclerk is acquired from the customer terminal.
33. The program according to supplementary note 32 described above, in which
   the computer can use a storage unit that stores, for each of the plurality of salesclerks, information indicating whether the salesclerk is available,
   the program further causing the computer to include:
   a state checking function of checking, by using the storage unit, whether the salesclerk being a target of the calling information is available when the calling information is acquired; and
   a reservation processing function of performing reservation processing for causing the salesclerk to serve the customer when the salesclerk is not available.
34. The program according to supplementary note 33 described above, in which
   the reservation processing function transmits information indicating that the reservation processing has been performed to a salesclerk terminal possessed by the salesclerk.
35. The program according to any one of supplementary notes 32 to 34 described above, in which
   the salesclerk terminal is a wearable terminal.
36. The program according to any one of supplementary notes 31 to 35 described above, in which
   the detailed information includes at least one of face information about the salesclerk, information about a specialty of the salesclerk, information about a company to which the salesclerk belongs, a self-introduction sentence input by the salesclerk, information about a product being actually used by the salesclerk, and information indicating whether the salesclerk is available.
37. The program according to any one of supplementary notes 31 to 36 described above, in which
   the salesclerk position transmission function transmits, to the customer terminal, information indicating whether the salesclerk is available in association with the salesclerk position information and the salesclerk identification information.
38. The program according to any one of supplementary notes 31 to 37 described above, further causing the computer to include,
   an evaluation information acquisition function of acquiring, from the customer terminal, evaluation information indicating an evaluation result of the salesclerk about whom the detailed information has been transmitted.
39. The program according to any one of supplementary notes 31 to 38 described above, in which
   the salesclerk position transmission function transmits, to the customer terminal, map information about the store together with the salesclerk position information in order to display a position of the salesclerk on a map of the store.
40. A program causing a computer to include:
   a salesclerk position transmission function of transmitting, for each of a plurality of salesclerks present in a store, salesclerk position information indicating a position of the salesclerk and salesclerk identification information that identifies the salesclerk in association with each other to a customer terminal possessed by a customer;
   a salesclerk selection function of selecting, when product determination information indicating a product selected by a customer is acquired from the customer terminal, the salesclerk associated with the product indicated by the product determination information, by using a storage unit that stores, for each of the plurality of salesclerks, a product of which the salesclerk is in charge; and
   a selection result transmission function of transmitting the salesclerk identification information about the salesclerk selected by using the salesclerk selection function to the customer terminal.
41. A customer terminal used together with the information transmission apparatus according to any one of supplementary notes 1 to 9 described above, the customer terminal including:
   a position display unit that causes a display to perform position display indicating a position of each of the plurality of salesclerks by using a plurality of pieces of the salesclerk position information;
   a transmission unit that transmits the salesclerk identification information about the salesclerk to the information transmission apparatus when any of the salesclerks is selected; and
   a detail display unit that causes the display to perform display of the detailed information when the detailed information is received from the information transmission apparatus.
42. The customer terminal according to supplementary note 41 described above, in which the position display unit also causes the display to display a position of the terminal.
43. A customer terminal used together with the information transmission apparatus according to supplementary note 10 described above, the customer terminal including:
   a map information display unit that causes a display to display a position of the salesclerk indicated by the salesclerk position information on a map about the inside of the store;
   a selection acquisition unit that receives an input of the product determination information; and
   a transmission unit that transmits the product determination information to the information transmission apparatus; in which
   the map information display unit displays, on the map in a distinguishable manner from another salesclerk, the salesclerk indicated by the salesclerk identification information transmitted by the selection result transmission unit.
44. The customer terminal according to supplementary note 43 described above, in which
   the selection acquisition unit
      receives an input of selection of a part of the map, and
      determines a product disposed at an area of the store associated with the part, and sets information indicating the product as the product determination information.
45. The customer terminal according to supplementary note 43 described above, in which
   the selection acquisition unit
      acquires a position of the customer in the store, and
      determines a product disposed around the position, and sets information indicating the product as the product determination information.

### REFERENCE SIGNS LIST

10 Information transmission apparatus
20 Customer terminal
30 Salesclerk terminal
110 Salesclerk position transmission unit
120 Detailed information transmission unit
130 Calling unit
140 State checking unit
150 Reservation processing unit
160 Evaluation information acquisition unit
170 Store information storage unit
180 Salesclerk information storage unit
210 Display
220 Position display unit
230 Transmission unit
240 Detail display unit
250 Selection acquisition unit
410 Salesclerk selection unit
420 Selection result transmission unit
502 Mark
504 Mark
510 Mark
520 Calling button

What is claimed is:

1. An information transmission apparatus comprising:
at least one memory configured to store instructions; and
at least one processor configured to execute the instructions to perform operations, the operations comprising:
transmitting, for each of a plurality of salesclerks present in a store, salesclerk position information indicating a position of the salesclerk and salesclerk identification information that identifies the salesclerk in association with each other to a customer terminal possessed by a customer;
reading, from a first storage unit that stores, for each of the plurality of salesclerks, the salesclerk identification information and detailed information about the salesclerk, the detailed information associated with the salesclerk identification information, when any piece of the salesclerk identification information is received from the customer terminal; and
transmitting the detailed information to the customer terminal.

2. The information transmission apparatus according to claim 1, wherein the operations further comprise
performing a predetermined output on a salesclerk terminal possessed by the salesclerk about whom the detailed information has been transmitted when calling information indicating that the customer calls the salesclerk is acquired from the customer terminal.

3. The information transmission apparatus according to claim 2, wherein
the information transmission apparatus can use a second storage that stores, for each of the plurality of salesclerks, information indicating whether the salesclerk is available,
the operations further comprise:
checking, by using the second storage, whether the salesclerk being a target of the calling information is available when the calling information is acquired; and
performing reservation processing for causing the salesclerk to serve the customer when the salesclerk is not available.

4. The information transmission apparatus according to claim 1, wherein
the detailed information includes at least one of face information about the salesclerk, information about a specialty of the salesclerk, information about a company to which the salesclerk belongs, a self-introduction sentence input by the salesclerk, information about a product being actually used by the salesclerk, and information indicating whether the salesclerk is available.

5. The information transmission apparatus according to claim 1, wherein the operations further comprise
transmitting, to the customer terminal, information indicating whether the salesclerk is available in association with the salesclerk position information and the salesclerk identification information.

6. The information transmission apparatus according to claim 1, wherein the operations further comprise
transmitting, to the customer terminal, map information about the store together with the salesclerk position information in order to display a position of the salesclerk on a map of the store.

7. (canceled)

8. An information processing method comprising,
by the customer terminal used together with the information transmission apparatus according to claim 1:
displaying a position of each of the plurality of salesclerks by using a plurality of pieces of the salesclerk position information;
transmitting the salesclerk identification information about the salesclerk to the information transmission apparatus when any of the salesclerks is selected; and
displaying the detailed information about the selected salesclerk when the detailed information is received from the information transmission apparatus.

9. An information transmission method comprising,
by a computer:
transmitting, for each of a plurality of salesclerks present in a store, salesclerk position information indicating a position of the salesclerk and salesclerk identification information that identifies the salesclerk in association with each other to a customer terminal;
reading, from a first storage that stores, for each of the plurality of salesclerks, the salesclerk identification information and detailed information about the salesclerk, the detailed information associated with the salesclerk identification information, when any piece of the salesclerk identification information is received from the customer terminal; and
transmitting the detailed information to the customer terminal.

10. (canceled)
